(19) United States
(12) Patent Application Publication
(10) Pub. No.: US 2025/0320966 A1
(43) Pub. Date: Oct. 16, 2025

(54) AIRCRAFT HYDROGEN DISTRIBUTION SYSTEM WITH A COMPRESSOR

(71) Applicant: Airbus Operations SAS, TOULOUSE (FR)

(72) Inventor: Guillaume RAVENEAU, TOULOUSE (FR)

(21) Appl. No.: 19/175,774

(22) Filed: Apr. 10, 2025

Related U.S. Application Data
(60) Provisional application No. 63/633,312, filed on Apr. 12, 2024.

(51) Int. Cl. F17C 7/04; B64D 27/40; B64D 37/04; B64D 37/30

(52) U.S. Cl. CPC F17C 7/04; B64D 27/40; B64D 37/04; B64D 37/30; F17C 2201/0109; F17C 2205/0323; F17C 2221/012; F17C 2223/0153; F17C 2227/0135; F17C 2227/0157; F17C 2227/0304; F17C 2250/03; F17C 2250/0636; F17C 2265/066; F17C 2270/0189

(57) ABSTRACT

A hydrogen distribution system for supplying hydrogen to a hydrogen consumer comprising: a tank storing a liquid hydrogen fuel; a conditioning system configured to provide a gaseous hydrogen stream downstream from the tank towards the hydrogen consumer; a compressor downstream of the conditioning system and configured to receive the gaseous hydrogen stream and provide a high-pressure gaseous hydrogen stream; a heater downstream of the compressor and configured to receive the high-pressure gaseous hydrogen stream and provide a high-temperature, high-pressure gaseous hydrogen stream; and, a valve downstream of the heater and configured to adjust a flow of the high-temperature, high-pressure gaseous hydrogen stream; wherein the hydrogen consumer is downstream of the valve and configured to receive the high-temperature, high-pressure gaseous hydrogen stream and provide energy by consuming hydrogen from the high-temperature, high-pressure gaseous hydrogen stream. Also, an aircraft with such a system.

### CROSS-REFERENCES TO RELATED APPLICATIONS

This application claims the benefit of the U.S. provisional patent application No. 63/633,312 filed on Apr. 12, 2024, the entire disclosure of which is incorporated herein by way of reference.

### FIELD OF THE INVENTION

The invention relates to hydrogen distribution systems and more particularly a hydrogen distribution system from a tank to a hydrogen consumer in an aircraft.

### BACKGROUND

It has been suggested that aircraft may utilize hydrogen for powering gas turbine engines or for use in fuel cells providing electricity to electrical motors driving a propeller of the aircraft. Hydrogen (H2) is stored as liquid hydrogen (LH2) in a cryogenic tank at a temperature of approximately −253° C. (roughly 20 Kelvin (K)). Hydrogen used by the consumers is gaseous hydrogen (GH2).

There are potential risks associated with liquid distribution that would be desirable to avoid or reduce including: overpressure in the vicinity of the fuel system after a liquid leak during temperature increase; overpressure in the fuel system in nominal/abnormal condition due to heat ingress (especially when flow is stopped); and high insulation needs to keep the hydrogen in liquid form especially in idle (low mass flow).

Additionally, in systems with a centrifugal pump associated with the engine, it is necessary to maintain the Net Positive Suction Pressure (“NPSP”) required at the inlet of high-pressure pump at all times. This is a complex matter especially during an idle phase and a quick transient phase.

Moreover, for systems with high pressure distribution (no additional pressurization at the engine), the distribution pipe technology is complex and it has to withstand rigorous thermal requirements (cycle with length change) and high pressure loads.

Finally, high pressure gaseous distribution require additional complexity in the fuel system due to conditioning close to the tank and distribution through the aircraft that it would be beneficial to avoid (e.g., fewer pumps, a heavy tank and heavy distribution pipes, etc.).

### SUMMARY OF THE INVENTION

An object of the present invention is to provide a hydrogen distribution system to distribute hydrogen from a tank to a hydrogen consumer in an aircraft, the hydrogen distribution system including a compressor for increasing the GH2 pressure. Preferably, the compressor is located in a powerplant system of the aircraft, for example in a pod of a hydrogen feed engine (or a pod containing another hydrogen consumer like fuel cells providing electricity to electrical motors driving a propeller of the aircraft). The compressor could also be located in the wing or in the fuselage. In such a case, it is preferably located the closest possible to the engine or the hydrogen consumer.

According to an example of the present system disclosed herein, using a compressor close to the engine will allow the system to feed engines (or other consumer) which need a high pressure at the interface while keeping a low-pressure gaseous distribution and will allow to use simple conditioning close to the tank.

There is a reduced risk in case of leakage as less hydrogen will be release for the same leak section.

The present system has a reduced mass and technology for the distribution of pipes (insulation, etc.).

Additionally, the present system provides a simplified conditioning close to the tank. For example, the present system utilizes a saturated tank (as opposed to a subcooled tank) associated with a thermodynamically stabilized state, which reduces the impact of sloshing effect. Moreover, a simplified conditioning system results in the avoidance or reduction of maintenance associated with pumps in the vicinity of a tank zone.

Further, the present system simplifies the engine interface (gaseous hydrogen) allowing simpler engine acceptance test (could be low or high pressure depending on the interface definition before or after the compressor).

According to an example disclosed herein, the fuel system close to the tank is composed of a saturated tank, a tank heater, a distribution heater and a low-pressure distribution pipe. The invention could be compliant with other aircraft fuel systems.

To that end, one aspect of the present invention is a hydrogen distribution system for supplying hydrogen to a hydrogen consumer. The system may include a tank storing a liquid hydrogen fuel, a conditioning system configured to provide a gaseous hydrogen stream downstream from the tank towards the hydrogen consumer, a compressor downstream of the conditioning system and configured to receive the gaseous hydrogen stream and provide a high-pressure gaseous hydrogen stream, a heater downstream of the compressor and configured to receive the high-pressure gaseous hydrogen stream and provide a high-temperature, high-pressure gaseous hydrogen stream, and a valve downstream of the heater and configured to adjust a flow of the high-temperature, high-pressure gaseous hydrogen stream. The hydrogen consumer may be downstream of the valve and configured to receive the high-temperature, high-pressure gaseous hydrogen stream and provide energy by consuming hydrogen from the high-temperature, high-pressure gaseous hydrogen stream.

The compressor may be located in a powerplant system of an aircraft.

The compressor may be located in a wing of an aircraft.

The compressor may be located in a fuselage of an aircraft.

The conditioning system may include a tank heater configured to maintain a pressure within the tank, and a distribution heater downstream of the tank and configured to vaporize liquid hydrogen and provide the gaseous hydrogen stream to the compressor.

The hydrogen distribution system may also include a heat transfer loop having, for example, an energy recuperator configured to transfer energy from the hydrogen consumer to a heat transfer fluid. The energy recuperator may heat the high-pressure gaseous hydrogen stream from the compressor via the heater utilizing the heat transfer fluid to provide the high-temperature, high-pressure gaseous hydrogen stream to the valve. The heat transfer loop may further include a pump configured to circulate the heat transfer fluid throughout the heat transfer loop to supply the heat transfer fluid to the heater.

The hydrogen consumer may be a combustion engine.

The hydrogen consumer may be a fuel cell.

The hydrogen distribution system may also include a controller configured to regulate a flow of hydrogen throughout the hydrogen distribution system.

In at least one aspect, the present invention provides an aircraft having a fuselage, a wing attached to the fuselage, a combustion engine mounted beneath the wing, and a fuel distribution system configured to distribute hydrogen fuel to the combustion engine according to the present disclosure.

### DETAILED DESCRIPTION OF THE DRAWINGS

Embodiments of the invention are described in more detail with reference to the accompanying schematic drawings that are listed below:

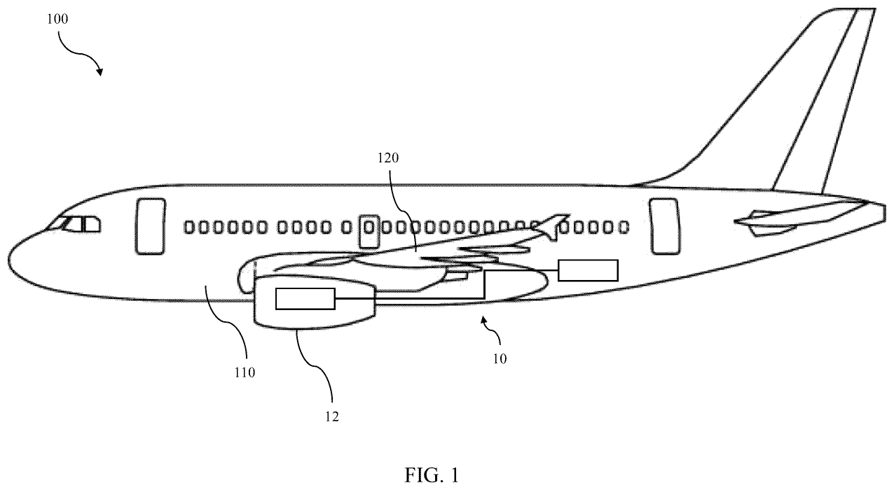

FIG. 1 is an aircraft including the hydrogen distribution system according to one or more embodiments of the present invention.

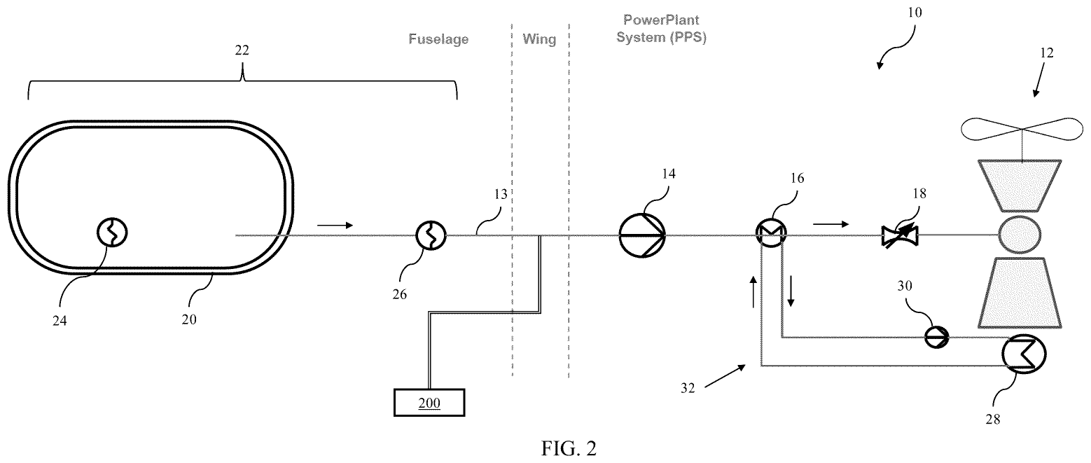

FIG. 2 schematically depicts a hydrogen distribution system according to one or more embodiments of the present invention.

### DETAILED DESCRIPTION

As mentioned above, a new system for supplying or distributing hydrogen has been invented which utilizes a compressor for GH2 supplied to a power producing hydrogen consumer on an aircraft.

With these general principles in mind, one or more embodiments of the present invention will be described with the understanding that the following description is not intended to be limiting.

FIG. 1 shows an aircraft 100 that has a fuselage 110 and a wing 120 attached to the fuselage 110 beneath which a combustion engine 12 is mounted. In the example of FIG. 1, the combustion engine 12 is a turbine engine, however, any other kind of engine or propulsion system may be interchangeably used such as a turbopropeller engine. As shown in FIG. 1, the aircraft 100 includes a hydrogen distribution system 10 for supplying/distributing GH2 to the combustion engine 12.

FIG. 2 shows a schematic view of the hydrogen distribution system 10 according to one or more embodiments of the present invention is depicted for supplying GH2 to the combustion engine 12 (for example a turbopropeller). In the example of FIG. 2, the hydrogen fuel is distributed from a tank 20 to the combustion engine 12 via a supply pipe 13 connecting the tank to the combustion engine 12.

While the embodiment of FIG. 2 is described for a system including the combustion engine 12, the present invention is not limited to such an application. For example, it is contemplated that the hydrogen distribution system 10 is provided in a propulsive system having fuel cells producing electricity for powering electrical motors driving a propulsive fan (via a gear box).

Returning to FIG. 2, the present system 10 includes a compressor 14 which provides a high-pressure GH2 stream. By “high” it is meant that pressure of the high-pressure GH2 stream is at least 10% higher compared with the GH2 stream provided to the compressor 14 (e.g., an output pressure of the compressor 14 is at least 10% higher than an input pressure of the compressor 14). For example, the input pressure of the compressor 14 is around 5 bars with a temperature of less than 30 Kelvin (K) and greater than 27 K. The output pressure of the compressor 14 may be, for example, around 35 bars with a temperature around 85K. Further, in some examples, the compressor may require around 54 kilowatts (kW) of power at takeoff and 11 kW of power during cruise operations of the aircraft 100.

As shown in FIG. 2, the compressor 14 (and likewise the components downstream towards the combustion engine 12) is located in the power plant system of the aircraft 100 (e.g., the combustion engine 12). In alternative examples, the compressor 14 is located in the wing 120 or the fuselage 110 of the aircraft 100. In these alternative examples, the compressor 14 is still located close in proximity to the combustion engine 12 to reduce leaks associated with long transfer pipes and instabilities due to pressure maintenance systems accompanying long transfer pipes distributing high pressure hydrogen fuel.

A main heater 16 is provided for heating the high-pressure GH2 stream to a target temperature and output a high-temperature, high-pressure GH2 stream. In some examples, the input qualities (e.g., pressure and temperature) of the GH2 of the main heater 16 is the same as the output qualities of the GH2 of the compressor 14 (e.g., around 35 bars and around 85 K).

Further, in some examples, the main heater 16 heats the GH2 without changing (or nominally changing) the pressure of the GH2. For example, the output pressure of the GH2 of the main heater 16 is 35 bars while the output temperature of the GH2 of the main heater 16 is around 300 K.

The output of the main heater 16 (e.g., the high-temperature, high-pressure GH2 stream) is provided to a valve 18. The valve 18 is configured for controlling a mass flow of the high-temperature, high-pressure GH2 stream to the combustion engine 12.

Also as shown in FIG. 2, the hydrogen distribution system 10 includes the tank 20 holding the LH2 fuel. In the examples provided herein, the hydrogen distribution system 10 converts the LH2 to the GH2, such that the GH2 is utilized by the combustion engine 12. In the example of FIG. 2, the LH2 is stored in the tank 20 at a pressure of 5 bars and a temperature of 27 K. The tank 20 is a saturated tank storing the LH2 fuel.

The hydrogen distribution system 10 of FIG. 2 also includes a conditioning system 22 functionally encompassing the tank 20 and is close to or proximate to the tank 20. The conditioning system 22 includes a tank heater 24 which is configured to maintain a tank pressure while extracting a stream of hydrogen from the tank 20, and a distribution heater 26 which is configured to heat the extracted stream of hydrogen and vaporize the LH2 to provide the GH2 stream that is passed to the compressor 14 (discussed above). In some examples, the output of the distribution heater 26 provides the GH2 to the compressor 14 at a pressure of around 5 bars and a temperature between 27 K and 30 K. This depicted conditioning system 22 is merely exemplary and may include additional or alternative elements for converting the LH2 to GH2.

Further, as shown in FIG. 2, the hydrogen distribution system 10 includes an energy recuperator 28 configured to recuperate or redistribute energy (e.g., heat) from the combustion engine 12. For example, the energy recuperator 28 may receive heat from exhaust gas of the combustion engine 12 and transmit the heat into a heat transfer fluid. A pump 30 circulates the heat transfer fluid through a heat transfer loop 32. The heater 16 may receive energy, such as heat, from the heat transfer fluid via the heat transfer loop 32 and transfer the energy to the GH2 stream to reach the targeted temperature and provide the high-temperature, high-pressure GH2 stream.

In some examples, according to the depicted hydrogen distribution system 10, the distribution of hydrogen is kept cryogenic to reduce the power needed by the compressor 14.

According to the example of FIG. 2, “downstream” is in reference to a flow of hydrogen from the tank 20 towards the combustion engine 12 via the supply pipe 13, while “upstream” is in reference to an opposite flow from the combustion engine 12 toward the tank 20. The flow of hydrogen throughout the hydrogen distribution system 10 of FIG. 2 is denoted by arrows along the supply pipe 13 and the heat transfer loop 32.

It should be appreciated and understood by those of ordinary skill in the art that various other components such as sensors, controllers, valves, pumps, filters, coolers, etc. were not shown in the drawings as it is believed that the specifics of same are well within the knowledge of those of ordinary skill in the art and a description of same is not necessary for practicing or understating the embodiments of the present invention.

The systems and devices described herein may include a controller 200 (or a computing device) comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller 200 (or computing device). Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A hydrogen distribution system for supplying hydrogen to a hydrogen consumer comprising:
a tank storing a liquid hydrogen fuel;
a conditioning system configured to provide a gaseous hydrogen stream downstream from the tank towards the hydrogen consumer;
a compressor downstream of the conditioning system and configured to receive the gaseous hydrogen stream and provide a high-pressure gaseous hydrogen stream;
a heater downstream of the compressor and configured to receive the high-pressure gaseous hydrogen stream and provide a high-temperature, high-pressure gaseous hydrogen stream; and,
a valve downstream of the heater and configured to adjust a flow of the high-temperature, high-pressure gaseous hydrogen stream;
wherein the hydrogen consumer is downstream of the valve and configured to receive the high-temperature, high-pressure gaseous hydrogen stream and provide energy by consuming hydrogen from the high-temperature, high-pressure gaseous hydrogen stream.

2. The hydrogen distribution system of claim 1, wherein the compressor is located in a powerplant system of an aircraft.

3. The hydrogen distribution system of claim 1, wherein the compressor is located in a wing of an aircraft.

4. The hydrogen distribution system of claim 1, wherein the compressor is located in a fuselage of an aircraft.

5. The hydrogen distribution system of claim 1, wherein the conditioning system comprises:
a tank heater configured to maintain a pressure within the tank; and
a distribution heater downstream of the tank and configured to vaporize liquid hydrogen and provide the gaseous hydrogen stream to the compressor.

6. The hydrogen distribution system of claim 1, further comprising a heat transfer loop including:
an energy recuperator configured to transfer energy from the hydrogen consumer to a heat transfer fluid,
wherein the energy recuperator heats the high-pressure gaseous hydrogen stream from the compressor via the heater utilizing the heat transfer fluid to provide the high-temperature, high-pressure gaseous hydrogen stream to the valve.

7. The hydrogen distribution system of claim 6, wherein the heat transfer loop further includes:
a pump configured to circulate the heat transfer fluid throughout the heat transfer loop to supply the heat transfer fluid to the heater.

8. The hydrogen distribution system of claim 1, wherein the hydrogen consumer is a combustion engine.

9. The hydrogen distribution system of claim 1, wherein the hydrogen consumer is a fuel cell.

10. The hydrogen distribution system of claim 1, further comprising a controller configured to regulate a flow of hydrogen throughout the hydrogen distribution system.

11. An aircraft comprising:
a fuselage;
a wing attached to the fuselage;
a combustion engine mounted beneath the wing; and
a fuel distribution system configured to distribute hydrogen fuel to the combustion engine according to the hydrogen distribution system of claim 1.
